(19) United States
(12) Patent Application Publication
(10) Pub. No.: US 2016/0209998 A1
(43) Pub. Date: Jul. 21, 2016

(54) METHOD AND APPARATUS FOR INPUTTING CONTENTS IN A TOUCH-SCREEN DEVICE

(71) Applicant: NOKIA TECHNOLOGIES OY, Espoo (FI)

(72) Inventors: Shuo Wang, Beijing (CN); Shaoqing Wang, Beijing (CN); Ningpeng Nie, Beijing (CN); Bokai Zeng, Beijing (CN)

(21) Appl. No.: 15/022,668

(22) PCT Filed: Sep. 18, 2014
(86) PCT No.: PCT/FI2014/050716

§ 371 Date: Mar. 17, 2016

(30) Foreign Application Priority Data
Sep. 26, 2013 (CN) 201310456938.X

(51) Int. Cl. G06F 3/0482; G06F 3/0488; H04M 1/725; G06F 3/0484

(52) U.S. Cl. CPC G06F 3/0482; G06F 3/04842; G06F 3/04883; H04M 1/72583

(57) ABSTRACT

The present invention relates to a method and apparatus for inputting content in a touch screen device. The method comprises: receiving content including selectable content items; receiving a single selection of at least one of the selectable content items; and in response to the single selection, adding the selected at least one of the selectable content items into response information for the received content. The present invention helps users quickly understand the received meaning to thereby make a response, and meanwhile reduces user input as much as possible, such that the user can operate flexibly and conveniently on a small or even micro touch-screen device.

### FIELD OF THE INVENTION

Embodiments of the present invention relate to the field of content input, and more specifically, to a method and apparatus for inputting contents in a touch-screen device.

### BACKGROUND OF THE INVENTION

With the constant development of the computer technology, the touch-screen technology has gained wide application in a variety of fields and now becomes a more prevalent technology. In past years, the touch-screen technology was often applied to a portable device so as to reduce the size and weight of the portable device as much as possible for the user easy to carry while facilitating user operation. For example, adopting the touch-screen technology on a mobile communication device such as a mobile phone may extend its various functions without increase the device size, thereby facilitating use by the user.

However, these applications also bring a new challenge because the touch-screen device becomes increasingly small-sized and portable, it has become a hot issue to study how to conveniently and quickly perform input in a limited (even mini) screen. In order to alleviate this problem, some solutions have been proposed. For example, by select-copy-paste in the displayed text content, the user's “soft keyboard” input may be reduced. However, although this manner reduces direct soft keyboard inputs, it at least needs three steps: select, copy, and paste. Besides, implementation of selecting always needs to double-click onto the text or select the start and end of the text, or needs assistance of other keys. On one hand, it cannot sufficiently reduce use of the soft keyboard, and on the other hand, the selected object is only limited to text.

In view of the above, a technology capable of quickly and effectively inputting on a touch-screen device is needed in this art.

### SUMMARY OF THE INVENTION

To this end, the present invention provides a method and apparatus for inputting contents in a touch-screen device.

According to one aspect of the present invention, there is provided a method of inputting content in a touch-screen device, comprising: receiving content including selectable content items; receiving a single selection of at least one of the selectable content items; and in response to the single selection, adding the selected at least one of the selectable content items into response information for the received content.

According to another aspect of the present invention, there is provided an apparatus of inputting content in a touch-screen device, comprising: a content receiving unit configured to receive content including selectable content items; a selection receiving unit configured to receive a single selection of at least one of the selectable content items; and a response information generating unit configured to, in response to the single selection, add the selected at least one of the selectable content items into response information for the received content.

According to a further aspect of the present invention, there is provided a non-transient computer-readable medium comprising a computer program product, which computer program product includes machine-executable instructions that, when executed, cause the machine to execute: receiving content including selectable content items; receiving a single selection of at least one of the selectable content items; and in response to the single selection, adding the selected at least one of the selectable content items into response information for the received content.

According to a still further aspect of the present invention, there is provided an apparatus, comprising: at least one processor; and at least one memory including computer program code; the at least one memory and the computer program code are configured to, with the at least one processor, cause the apparatus to at least execute: receiving content including selectable content items; receiving a single selection of at least one of the selectable content items; and in response to the single selection, adding the selected at least one of the selectable content items into response information for the received content.

It would be understood through the following description that according to the embodiments of the present invention, when it is desired to input content on the touch-screen device so as to respond to the received content, if the received content has at least a part of the content desired to input, it may act as at least a part of the response information only through single selecting the received content. Therefore, the user input is effectively reduced. Moreover, according to some alternative embodiments, the received content may be resolved to help users to quickly understand its meaning to thereby make a response. On this basis, user operation of inputting the same content may be further simplified, such that the user can operate flexibly and conveniently on a small or even micro touch-screen device.

### BRIEF DESCRIPTION OF THE ACCOMPANYING DRAWINGS

FIG. 1 shows a flow diagram of a method 100 for inputting content in a touch-screen device according to one exemplary embodiment of the present invention;

FIG. 2 shows a flow diagram of a method 200 for inputting content in a touch-screen device according to another exemplary embodiment of the present invention;

FIGS. 3A-3D show a specific example of inputting content according to one exemplary embodiment of the present invention;

FIGS. 4A-4C show a specific example of inputting content according to another exemplary embodiment of the present invention;

FIGS. 5A-5C show a specific example of inputting content according to a further exemplary embodiment of the present invention;

FIG. 6 shows a block diagram of an apparatus 600 of inputting content in a touch-screen device according to one exemplary embodiment of the present invention;

FIG. 7 shows a user terminal 700 in which exemplary embodiments of the present invention may be implemented therein; and

FIG. 8 schematically shows a configuration diagram of the user terminal as shown in FIG. 7.

It should be noted that the flow diagrams and block diagrams in the drawings illustrate possibly implemented system architecture, functions and operations of the apparatus, method and computer program product according to various embodiments of the present invention. On this point, each block in the flow diagram or block diagram may represent a module, a program segment, or a part of code; the module, program segment, or a part of code includes one or more executable instructions for performing prescribed logic functions. It should also be noted that in some alternative implementations, the functions labelled in the blocks may also occur in an order different from what is labelled. For example, two consecutively represented blocks may actually be performed substantially in parallel; and sometimes, they may also be performed in reverse order, dependent on the related functions. It should also be noted that each block in the block diagrams and/or flow diagrams and combinations of the blocks in the block diagrams and/or flow diagrams may also be implemented using a dedicated hardware-based system for performing prescribed functions or operations, or implemented using a combination of dedicated hardware and computer instructions.

### DETAILED DESCRIPTION OF THE PREFERRED EMBODIMENTS

Hereinafter, the principle and spirit of the present invention will be described with reference to several exemplary embodiments as illustrated in the drawings. It should be understood that these embodiments are described only for enabling those skilled in the art to better understand and further implement the present invention, not intended to limit the scope of the present invention in any manner.

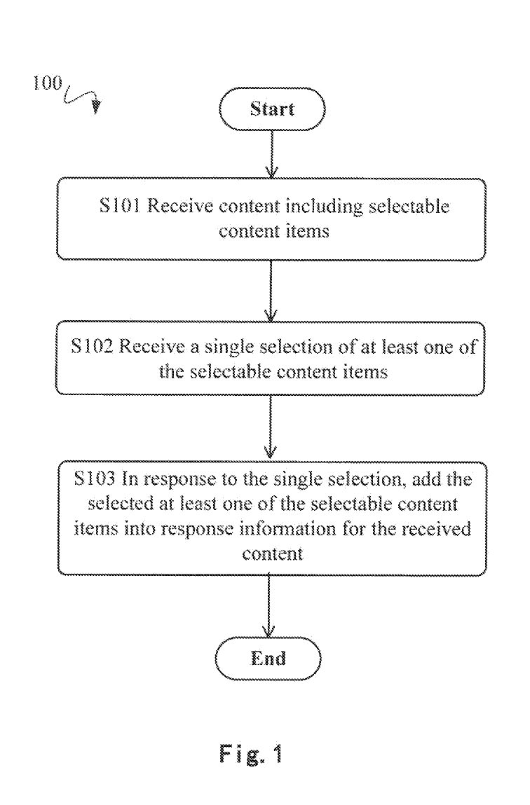

First, referring to FIG. 1, in which a flow diagram of a method 100 for inputting content in a touch-screen device according to one exemplary embodiment of the present invention is presented. It should be noted that, in the context of the present application, the term “touch-screen device” comprises a device using a touch-screen technology in the broadest sense. The touch-screen technology in the broadest sense may not only refer to a technology of using a finger or other object to touch a touch screen installed at a front end of a display, but also may refer to a floating touch-screen technology that may implement a touch operation without contacting the touch screen. For example, through the floating touch technology, a finger or other object is allowed not to directly contact the screen; instead, an operation like mouse may be performed on the touch-screen device within a certain distance range from the screen, and manipulation is enabled only by suspending the finger or other object over the screen. Besides, contacting the screen through texture like a glove to manipulate the device is also a manner of “touch-screen.” The “touch-screen device” may also include a portable touch-screen device, e.g., a mobile communication device (e.g., mobile phone), a PDA, IPAD, and the like, which adopt the touch-screen technology. The scope of the present invention is not limited in this regard.

As shown in the figure, after the method 100 starts, in step S101, content including selectable content items is received. Here, the received content may include a short message such as a mobile phone short message received through mobile communication network, various kinds of instant messages such as multimedia messaging services MMS, Wechat, messages from social applications (QQ, WeChat, etc.), email, Weibo, and commentaries of Weibo, etc. The term “selectable content items” as used refers to content items that can be selected in the received content. For example, they commonly may include words and/or pictures. In the example in which the received content is a mobile phone short message, each word, symbol or picture in the short message may be a “selectable content item.”

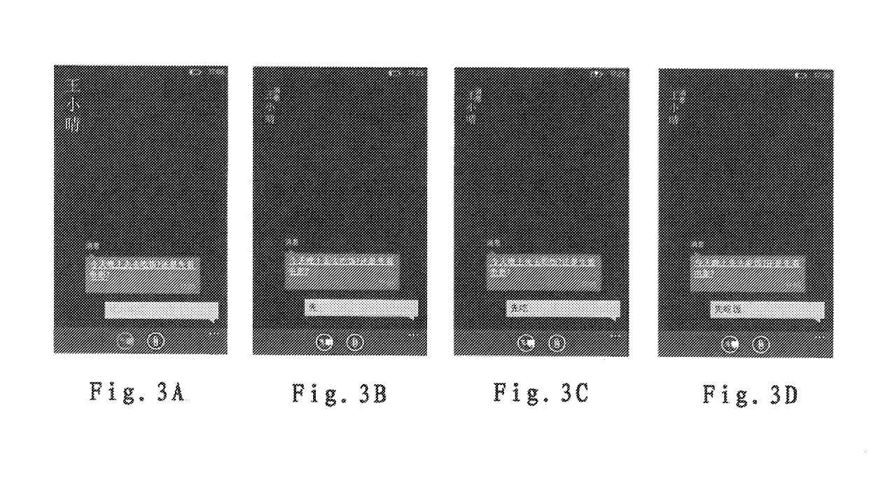

Next, the method 100 proceeds to step S102, in which a single selection of at least one of the selectable content items is received. The term “single selection” here includes a single click, single touch or single slide on the touch screen, but does not include a selection that needs two or more touches. In order to clearly illustrate the method 100, FIGS. 3A-3D are referenced. FIGS. 3A-3D show a specific example of inputting content according to one exemplary embodiment of the present invention. As shown in FIG. 3A, when receiving a mobile phone short message “ [symbol] [symbol] [symbol] ” from the contact Wang Xiaoqing, a selectable content item “ [symbol] ” may be selected by touch “ [symbol] ” once on the touch screen, as shown in FIG. 3B, and then, selectable content items “ [symbol] ” and “ [symbol] ” are selected successively by touching “ [symbol] ” and “ [symbol] ,” respectively, as shown in FIG. 3C and FIG. 3D. Alternatively, a plurality of selectable items “ [symbol] ” may be selected once for all by sliding from “ [symbol] ” to “ [symbol] ” on the screen (not shown in FIGS. 3A-3D).

Return to method 100. Next, in step S103, in response to the single selection, at least one of the selectable content items are added into response information for the received content in response to the single selection. This step may automatically display the at least one selectable content item selected in step S102 in an input box, as at least a part of the response information with respect to the received content. The term “response information” includes various forms of responses to the received content. For example, when the received content is a short message, the response information may be a replied short message; when the received content is an instant message, the response information may be a reply instant message; when the received content is an email, the response information may be a replied email; while when the received content is a Weibo or a commentary on the Weibo, the response information may be a posted commentary. Still refer to FIGS. 3A-3D, after touching “ [symbol] ” once, “ [symbol] ” may be automatically shown in the input region (FIG. 3B); and after successively touching “ [symbol] ” and “ [symbol] ,” “ [symbol] ” and “ [symbol] ” are automatically displayed in the input region after successively touching “ [symbol] ” and “ [symbol] ” (see FIGS. 3C and 3D), as at least a part of the replied short message. Similarly, “ [symbol] ” is automatically shown in the input area after sliding to select “ [symbol] ,” as at least a part of the replied short messages (not shown in FIGS. 3A-3D).

Alternatively or additionally, the selected at least one selectable content item may be added to any location in the response information. For example, when receiving a mobile phone short message “ [symbol] [symbol] [symbol] ”, after inputting “ [symbol] .” using a traditional input manner (e.g., soft keyboard), “ [symbol] ” is input through steps S102 and S103 according to the present invention, and then “ [symbol] ” is input also in a traditional input manner. Additionally, optionally, a traditional input mode and a fast input mode may be set for the touch-screen device, wherein in the traditional input mode, input is made using a soft keyboard, while in the fast input mode, the input is made according to the method of inputting content of the present invention. The traditional input mode and the fast input mode may be switched through a specific icon or shortcut key, for example.

In the embodiment depicted in FIG. 1, the method 100 ends after step S103. Based on this embodiment of the present invention, in the case of receipt of the content including selectable content items and intending to respond to it (e.g., reply or commentary), it may be convenient to single select at least one selectable content item therein as at least a part of the response information in the input area. In this way, distinct from the prior art, the method of inputting content according to the present invention simplifies the step of input on one hand, and also reduces the number of clicks needed to perform the selection to the utmost extent. In a touch-screen device with a small or even mini touch-screen device, the method of inputting content according to the present invention can significantly alleviate a user's burden, such that the user can input content quickly and conveniently.

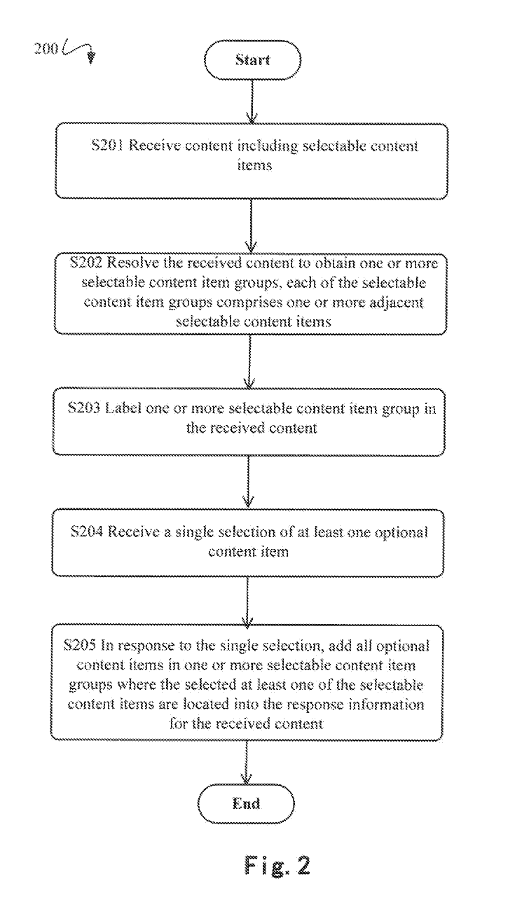

Hereinafter, a method 200 for inputting content in a touch-screen device according to another exemplary embodiment of the present invention will be described with reference to FIG. 2. The method 200 may be regarded as a further preferable implementation of the method 100 as described above with reference to FIG. 1. As shown in the figure, after start of the method 200, in step S201, content including selectable content items is received. This step is similar to step S101 of the method 100 described with reference to FIG. 1, wherein meanings of various terms are similar to those defined in step S101, which will not be detailed here.

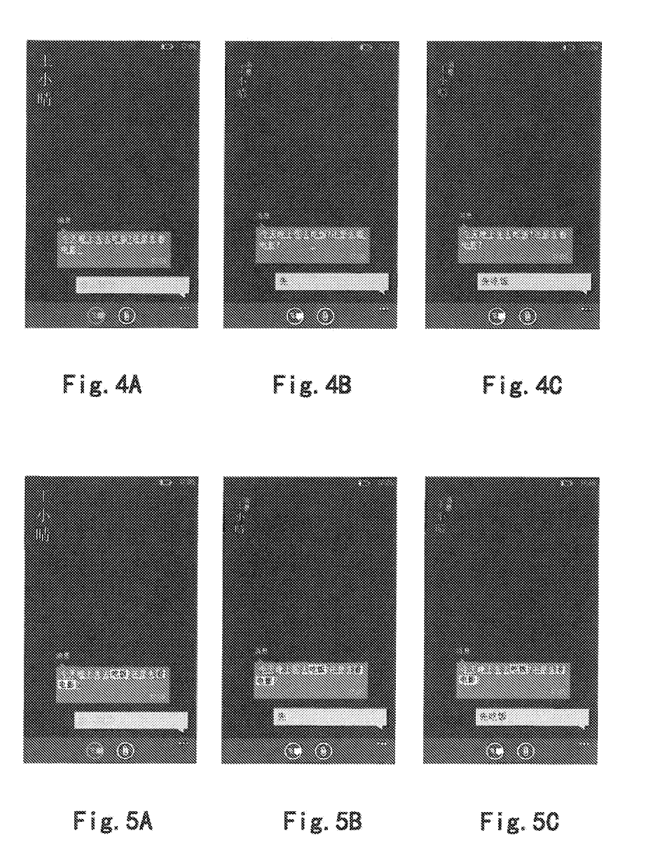

Next, in step S202, the received content is resolved to obtain one or more selectable content item groups, each of the selectable content item groups comprises one or more adjacent selectable content items. In the example in which the received content is a mobile phone short message and the selectable content item is the textual word, the selectable content item group may be a phrase composed a single word or a plurality of adjacent words. In a preferred embodiment, parsing may be conducted based on semantics and/or context. FIGS. 4A-4C show another specific example of inputting content according to an exemplary embodiment of the present invention. As shown in FIG. 4A, the received mobile phone short message “ [symbol] [symbol] [symbol] ” is subject to semantic resolution, obtaining the following plurality of phrase groups (i.e., selectable content item groups): “ [symbol] [symbol] ,” “ [symbol] ,” “ [symbol] ,” “ [symbol] ,” “ [symbol] ,” “ [symbol] ,” “ [symbol] ,” “ [symbol] ,” “ [symbol] .” These phrase groups include a textual word or a phrase composed of adjacent textual words.

Return to method 200. In step S203, one or more selectable content item groups in the received content are labelled. Still refer to FIG. 4A, the resulting respective phrase groups obtained from the previous resolution are labelled in the received short message. In FIG. 4A, the phrase group (selectable content item group) is labelled by underlining. However, those skilled in the art should understand that the labeling manner is not limited thereto, which may also comprise various labeling manners in the prior art, such as highlighting, parenthesizing, modifying the ground color, modifying the font color, modifying the type size, etc. Besides, overlapping of multiple labelling manners may also be adopted simultaneously.

The labeled received content may provide a direct prompt to the user of a touch-screen device, facilitating the user to quickly understand the meaning of the received content, thereby responding to it. For example, with reference to FIG. 4B, the user with prompt may quickly find “ [symbol] ” which is desired to be a part of reply, and click selection is performed in a manner similar to steps S102-S103 of the method 100 with reference to FIG. 1, which will not be detailed here (not shown in FIG. 2).

Nevertheless, the method of inputting content according to the present invention may also comprise another optional and preferred embodiment. With reference to FIG. 2, after receiving the single selection of at least one optional content item in step S204 (similar to step S102 of the method 100), the method 200 may optionally proceed to step S205, in which, in response to the single selection, all optional content items in one or more selectable content item groups where the selected at least one of the selectable content items are located are added into the response information for the received content. With FIG. 4C as an example, whether it is the selectable content item “ [symbol] ” or “ [symbol] ” in the selectable content item group “ [symbol] ” that is clicked, “ [symbol] ” is automatically added as at least a part of the response information.

In relation, the method of inputting content according to the present invention may be optionally further extended. For example, step S204 may include receiving single selection of an area between adjacent two selectable content items belonging to the same selectable content item group. Correspondingly, step S205 may include, in response to single selection of the area, adding all selectable content items in the same selectable content item group into response information for the received content. Still with FIG. 4C as an example, even it is the gap area between “ [symbol] ” and “ [symbol] ” that is clicked, in the implementation of the present invention, “ [symbol] ” is still automatically added into the response information.

In the preferred implementation according to the present invention, at least two labels for different the selectable content item groups may be different. Here, the term “different” not only comprises adopting different labels (for example, the label for one selectable content item group is underline, while the label for another selectable content item group is highlight), but also comprises a scenario where although the same labels are adopted, but they do not overlap (e.g, the label for one selectable content item group is underline, while the label for another selectable content item group is underline plus highlight). Besides, the adopted label may become more significant with the important degree of the selectable content item group. FIGS. 5A-5C show a specific example of inputting content according to a further exemplary embodiment of the present invention. As shown in FIG. 5A, in the plurality of selectable content item group obtained from resolution, the more important content items “ [symbol] ,” “ [symbol] ,” and “ [symbol] ” simultaneously adopt two labels: underline and highlight, while the remaining relatively unimportant content items only adopt one label of underline. In this way, it facilitates the user to capture key information, thereby make a prompt response. The operations of FIGS. 5B and 5C are respectively similar to the operations described with reference to FIGS. 4B and 4C, which will not be detailed here.

By far, the method 200 ends. According to this embodiment of the present invention, a direct and clear prompt regarding the received content may be provided to a user of the touch-screen device, and meanwhile key information can be highlighted. Based on the prompt and/or key information, user input is further reduced.

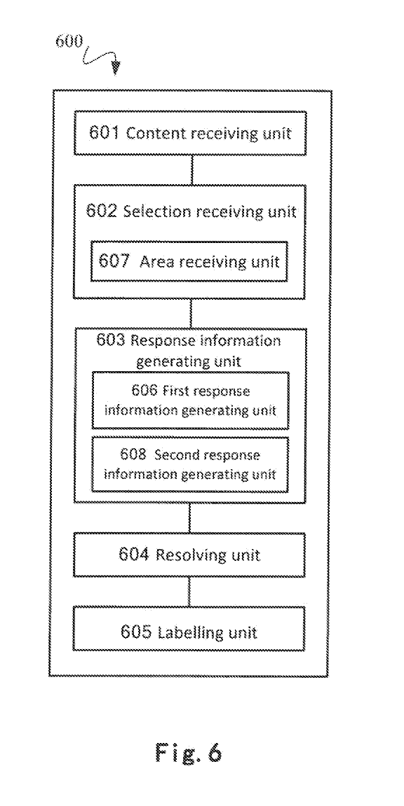

Now refer to FIG. 6, in which a block diagram of an apparatus 600 for inputting content in a touch-screen device according to one exemplary embodiment of the present invention is presented. Those skilled in the art should understand that, for the sake of brevity, in the depiction of the apparatus 600 infra, terms similar to what have been mentioned above have similar meanings. As shown in the figure, the apparatus 600 comprises: a content receiving unit 601, a selection receiving unit 602, and a response information generating unit 603, wherein the content receiving unit 601 is configured to receive content including selectable content items; the selection receiving unit 602 is configured to receive a single selection of at least one of the selectable content items; and the response information generating unit 603 is configured to, in response to the single selection, add the selected at least one of the selectable content items into response information for the received content.

According to some embodiments, the single selection comprises a single click or a slide selection on the touch screen.

According to some embodiments, the apparatus 600 may further include a resolving unit 604 and a labelling unit 605, wherein the resolving unit 604 is configured to resolve the received content so as to obtain one or more selectable content item groups, each of the selectable content item groups comprising one or more adjacent selectable content items; the labeling unit 605 is configured to label the one or more selectable content item groups in the received content.

According to some embodiments, the response information generating unit 603 comprises a first response information generating unit 606 configured to, in response to the single selection, add one or more selectable content item groups where the selected at least one selectable content item is located into response information for the received content.

According to some embodiments, the selection receiving unit 602 comprises an area receiving unit 607 configured to receive a single selection of an area between two selectable content items belonging to the same selectable content item group; and the response information generating unit 603 further comprises a second response information generating unit 608 configured to in response to the single selection of the area, add all selectable content items in the same selectable content item group into response information to the received content.

According to some embodiments, the label includes at least one of the followings: highlighting, underlining, parenthesizing, modifying the ground color, modifying the font color, and modifying the type size.

According to some embodiments, at least two labels for the different selectable content item groups are different.

According to some embodiments, the resolution is performed based on semantics and/or context.

According to some embodiments, the received content includes one of the followings: short message, instant message, email, Weibo, and commentaries on Weibo.

According to some embodiments, the selectable content items include words, symbols and/or pictures.

According to some embodiments, the touch-screen device comprises a portable touch-screen device.

It should be noted that, for the convenience of illustration, a resolving unit 604 and a labelling unit 605 are shown in the apparatus 600 in FIG. 6. However, it should be understood that these units are not essential, but alternative or optional. Likewise, although it is shown in apparatus 600 in FIG. 6 that the selection receiving unit 602 comprises an area receiving unit 607, and the response information generating unit 603 comprises a first response information generating unit 606 and a second response information generating unit 608, units 606-608 are optional, and the scope of the present invention is not limited in this regard. Moreover, the term “unit” used here may be a hardware module or a software module. Accordingly, apparatus 600 may be implemented in various forms. For example, in some embodiments apparatus 600 may be implemented using software and/or firmware partially or completely, e.g., implemented as a computer program product embodied on a computer readable medium. Alternatively or additionally, apparatus 600 may be implemented partially or completely based on hardware, for example, implemented as an integrated circuit (IC) chip, application-specific integrated circuit (ASIC), system on chip (SOC) or field programmable gate array (FPGA). The scope of the present invention is not limited in this regard.

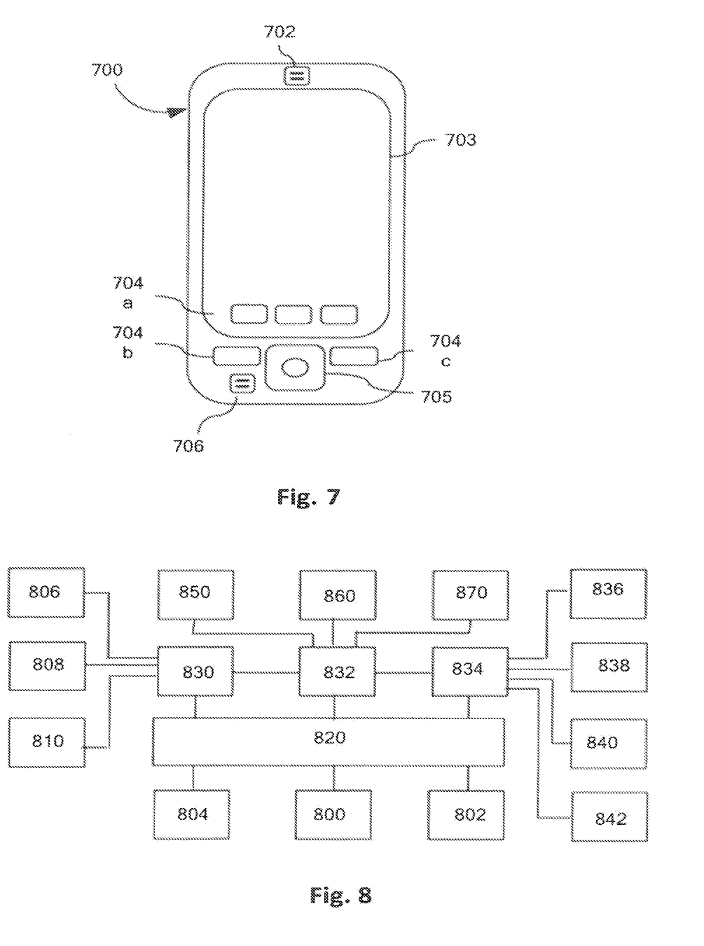

FIG. 7 schematically illustrates a user terminal 700 in which exemplary embodiments of the present invention may be implemented.

The user terminal 700 comprises a loudspeaker or an earphone 702, microphone 706, touch screen 703, and a set of keys 704 that may include a virtual key 704a, a soft key 704b, 7004c, and a joystick 705 or other type of navigation input device.

FIG. 8 schematically illustrates a configuration diagram of the user terminal shown in FIG. 7.

Now, refer to FIG. 8, in which the internal components, software and protocol structure of the user terminal 700 is described. The user terminal 700 comprises a controller 800 responsible for the overall operation of the user terminal and may be implemented using any commercially-available CPU (“Central Processing Unit),” DSP (Digital Signal Processor) or any other electronic programmable device. The controller 800 comprises an associated electronic memory 802, such as a RAM memory, a ROM memory, an EEPROM memory, a flash disk or any combination thereof. The memory 802 is controlled by the controller 800 for various purposes, one of which lies in storing program instructions and data for various kinds of software in the user terminal. The software comprises a real-time operating system 820, a driver for human-machine interface (MMI) 834, an application processor 832, and various applications. The applications may include a message text editor 850, a handwriting recognition (HWR) application 860, and various kinds of other applications 870, e.g., voice call, video call, transmission and reception of short message service (SMS) messages, multimedia messaging service (MMS) or email, web browsing, instant messaging trasceiving application, phone directory application, calendar application, etc. It should be noted that two or more of the above applications may be executed as the same application.

The MMI 834 further comprises one or more hardware controllers, which coordinate, along with an MMI driver, with a first display 836/703, keypad 838/704 and various kinds of other I/O devices (such as microphone, loudspeaker, ringer, ring generator, LED indicator, etc.). As is well known, the user may operate the user terminal through such formed human-machine interface.

The software may further comprise various modules, protocol stacks, drivers, etc., which are commonly labelled as 830, and provide communication services (such as, transmission, network, and conductivity) for RF interface 806 and optionally, for the Bluetooth interface 808 and/or IrDA interface 810, so as to be available for the local conductivity. The RF interface 806 comprises an internal or external antenna and an appropriate radio circuit for establishing and maintaining a radio link to the base station. As is well known to those skilled in the art, the radio circuit comprises a series of analog and digital electronic components, which together form a radio receiver and a radio transmitter. These components, for example, comprise a bandpass filter, an amplifier, a frequency mixer, a local oscillator, a lowpass filter, and an AD/DA converter, etc.

The user terminal may also comprise a SIM card 804 and an associated reader. As is well known, the SIM card 804 comprises a processor and a local work and data memory.

It should be noted that embodiments of the present invention may be implemented through hardware, software or a combination of hardware and software. The hardware part may be implemented using a dedicated logic; the software part may be stored in the memory, executed by an appropriate instruction executing system, e.g., a microprocessor or a dedicatedly designed hardware. A person of normal skill in the art may understand that the above apparatus and method may be implemented using a computer-executable instruction and/or included in processor control code. In implementation, such code is provided on a medium such as magnetic disk, CD or DV_ROM, a programmable memory such as read-only memory (firmware), or a data carrier such as optical or electronic signal carrier.

In one example, there is provided a non-transient computer-readable medium of a computer program product that comprises a machine-executable instruction, which machine-executable instruction, when being executed, enables the machine to execute: receiving content including selectable content items; receiving a single selection of at least one of the selectable content items; and in response to the single selection, adding the selected at least one of the selectable content items into response information for the received content.

In another example, there is provided an apparatus, comprising: at least one processor; and at least one memory including computer program code; the at least one memory and the computer program code are configured to, with the at least one processor, cause the apparatus to at least execute: receiving content including selectable content items; receiving a single selection of at least one of the selectable content items; and in response to the single selection, adding the selected at least one of the selectable content items into response information for the received content.

The apparatus and its modules of the present invention can be implemented by a very large scale integrated circuit or gate array, semiconductor such as logic chips and transistors, or hardware circuitry of programmable hardware devices like field programmable gate arrays and programmable logic devices, or implemented by various kinds of processor-executable software, or implemented by a combination of the above hardware circuits and software, such as firmware.

Note although several units or sub-units of the apparatus have been mentioned in the above detailed description, such division is merely exemplary and not mandatory. In fact, according to embodiments of the present invention, the features and functions of two or more modules described above may be embodied in one module. On the contrary, the features and functions of one module described above may be embodied by a plurality of modules.

In addition, although in the accompanying drawings operations of the method of the present invention are described in specific order, it is not required or suggested these operations be necessarily executed in the specific order or the desired result should be achieved by executing all illustrated operations. On the contrary, the steps depicted in the flowcharts may change their execution order. Additionally or alternatively, some steps may be omitted, a plurality of steps may be combined into one step for execution, and/or one step may be decomposed into a plurality of steps for execution.

Although the present invention has been described with reference to several embodiments, it is to be understood the present invention is not limited to the embodiments disclosed herein. The present invention is intended to embrace various modifications and equivalent arrangements comprised in the spirit and scope of the appended claims. The scope of the appended claims accords with the broadest interpretation, thereby embracing all such modifications and equivalent structures and functions.

1-26. (canceled)

27. A method of inputting content in a touch-screen device, comprising:
receiving content including selectable content items;
receiving a single selection of at least one of the selectable content items; and
in response to the single selection, adding the selected at least one of the selectable content items into response information for the received content.

28. The method of claim 27, wherein the single selection comprises a single click or a slide selection on the touch screen.

29. The method of claim 28, wherein the click or slide is performed in a floating touch-screen manner.

30. The method of claim 27, further comprising:
resolving the received content so as to obtain one or more selectable content item groups, each of the selectable content item groups comprising one or more adjacent selectable content items; and
labeling the one or more selectable content item groups in the received content.

31. The method of claim 30, wherein in response to the single selection, adding the selected at least one of the selectable content items into response information with respect to the received content comprises:
in response to the single selection, adding all selectable content items in one or more selectable content item groups where the selected at least one of the selectable content items are located into response information for the received content.

32. The method of claim 30, wherein receiving a single selection of at least one of the selectable content items comprises:
receiving a single selection of an area between two adjacent selectable content items belonging to the same selectable content item group;
and in response to the single selection, adding the selected at least one of the selectable content items into response information for the received content comprises:
in response to the single selection of the area, adding all selectable content items in the same selectable content item group into response information to the received content.

33. The method of claim 30, wherein the label includes at least one of the followings: highlighting, underlining, parenthesizing, modifying the ground color, modifying the font color, and modifying the type size.

34. An apparatus, comprising:
a content receiving unit configured to receive content including selectable content items;
a selection receiving unit configured to receive a single selection of at least one of the selectable content items; and
a response information generating unit configured to, in response to the single selection, add the selected at least one of the selectable content items into response information for the received content.

35. The apparatus of claim 34, wherein the single selection comprises a single click or a slide selection on the touch screen.

36. The apparatus of claim 35, wherein the click or slide is performed in a floating touch-screen manner.

37. The apparatus of claim 34, further comprising:
a resolving unit configured to resolve the received content so as to obtain one or more selectable content item groups, each of the selectable content item groups comprising one or more adjacent selectable content items; and
a labelling unit configured to label the one or more selectable content item groups in the received content.

38. The apparatus of claim 37, wherein the response information generating unit comprises:
a first response information generating unit configured to, in response to the single selection, add into response information for the received content all selectable content items in one or more selectable content item groups where the selected at least one of the selectable content items are located.

39. The apparatus of claim 37, wherein the selection receiving unit comprises:
an area receiving unit configured to receive a single selection of an area between two adjacent selectable content items belonging to the same selectable content item group;
and the response information generating unit comprises:
a second response information generating unit configured to, in response to the single selection of the area, add all selectable content items in the same selectable content item group into response information to the received content.

40. The apparatus of claim 37, wherein the label includes at least one of the followings: highlighting, underlining, parenthesizing, modifying the ground color, modifying the font color, and modifying the type size.

41. The apparatus of claim 37, wherein at least two labels for the different selectable content item groups are different.

42. The apparatus of claim 37, wherein the resolution is performed based on semantics and/or context.

43. The apparatus of claim 34, wherein the received content includes one of the followings: short message, instant message, email, Weibo, and commentaries on Weibo.

44. The apparatus of claim 34, wherein the selectable content items include words, symbols and/or pictures.

45. The apparatus of claim 34, wherein the touch screen device comprises a portable touch screen device.

46. A computer program embodied on a non-transitory computer readable medium, the computer program comprising instructions causing, when executed on at least one processor, at least one apparatus to:
receive content including selectable content items;
receive a single selection of at least one of the selectable content items; and
in response to the single selection, add the selected at least one of the selectable content items into response information for the received content.
